(19) United States
(12) Patent Application Publication
(10) Pub. No.: US 2025/0158097 A1
(43) Pub. Date: May 15, 2025

(54) CONCENTRATED VRFB ELECTROLYTE COMPOSITION AND METHOD FOR PRODUCING SAME

(71) Applicant: Largo Clean Energy Corp., Wilmington, MA (US)

(72) Inventor: Michael L. PERRY, Noank, CT (US)

(73) Assignee: Largo Clean Energy Corp., Wilmington, MA (US)

(21) Appl. No.: 18/840,837

(22) PCT Filed: Feb. 23, 2023
(86) PCT No.: PCT/US2023/013696

§ 371 Date: Aug. 22, 2024

Related U.S. Application Data
(60) Provisional application No. 63/312,999, filed on Feb. 23, 2022.

(51) Int. Cl. H01M 8/08; H01M 8/18

(52) U.S. Cl. CPC H01M 8/08; H01M 8/188; H01M 2300/0011

(57) ABSTRACT

There is disclosed a method for producing a concentrated VRFB electrolyte composition. The method comprises the following steps: (a) mixing a vanadium, oxide, water and aqueous H₂SO₄ in sufficient quantities to produce a reaction mixture comprising a vanadium sulfate at a concentration at least 3.0 M and a total sulfate concentration of at least 2 times the concentration of the vanadium sulfate; (b) maintaining the reaction mixture at an initial temperature that substantially avoids precipition of reaction solids; (c) allowing the reaction mixture to reach ambient temperature: and (d) increasing the viscosity of the reaction mixture to produce the concentrated VRFB electrolyte composition. There is also disclosed a concentrated VRFB electrolyte composition. The concentrated VRFB electrolyte is believed to provide advantages include reduced shipping costs, logistics and on-site capital costs at the facility using the VRFBs.

### CROSS-REFERENCE TO RELATED APPLICATION

The present application claims the benefit under 35 U.S.C. § 119(e) of provisional patent application Ser. No. 63/312,999, filed Feb. 23, 2022, the contents of which are hereby incorporated by reference.

### BACKGROUND OF THE INVENTION

### Field of the Invention

In one of its aspects, the present invention relates to a method for producing a concentrated VRFB electrolyte composition. In another of its aspects, the present invention relates to a concentrated VRFB electrolyte composition, per se and/or produced by this method. In another of its aspects, the present invention relates to a composition which may be used to form a VRFB electrolyte composition. In another of its aspects, the present invention relates to use of the concentrated VRFB electroyte composition to produce a VRFB electrolyte composition.

### Description of the Prior Art

Vanadium redox flow batteries (also referred interchangeably throughout this specification as “VRFBs”) are an emerging energy storage system, capable of making stationary energy storage viable in commercial settings with the potential of effectively storing renewable energy. VRFBs are an alternative to Li-Ion batteries specifically in the area of large-scale energy storage, with the ability to hold large energy capacities suitable for industrial use, along with a 20+ year lifespan and being intrinsically safer with no risk of thermal runaway they are a leading contender for industrial decarbonisation.

For the VRFB industry, vanadium electrolyte is one of the vital components of a flow battery. Typically manufactured using a wet chemistry approach, this requires the addition of chemical reagents. Vanadium redox flow batteries are currently being deployed around the world as a large-scale energy storage solution, using higher purity VRFB electrolyte leads to improved battery performance and lifetime.

In the future, it is believed that large-scale energy storage has a fundamental part in decarbonising industry and creating a more sustainable future, potentially providing the capability to stabilise and better utilise renewable energy sources. It is believed that VRFBs have an important role in energy transition for decades to come, and for commercial applications, the highest quality VRFB electrolyte is expected to facilitate performance and a long cycle life.

Despite the significant potential for VRFBs, there is room for improvement.

A particular problem which appears not to have been satisfactorily addressed is distribution of VREB electrolye to facilities operating VRFBs. There are two options currently in use and each has its own deficiencies.

The first option is to ship finished VRFB electrolye to the VRFB facility. A problem with this option is the high cost of shipping a product which is mostly water. In addition, there are complex logistics associated with this option, including shipping hazardous liquids and filling smaller vessels (e.g., totes) with the finished VRFB. These logistics are necessary since it is not generally permitted to transport finished VRFB in large shipping containers and tanker trucks due to weight contraints and excessive sloshing/splashing of the product.

The second option is to ship the chemicals needed to produce finished VRFB eletrolyte to the VRFB facility. However, this option requires that each VRFB facility incur the capital expense and inconvenience associated with complex handling and metering of the components needed to produce the VRBB electrolye on site. Even if this electrolyte preparation equipment is only placed on site temporarily, the cost of moving this complex equipment is significant and there can also be limited space available to site this additional equipment.

Accordingly, there remains a need in the art for a VRFB eletrolyte product that obviates or mitigates the above mentioned problems. It would be particularly advantageous if such a product could be produced without the need for complex additional equipment.

### SUMMARY OF THE INVENTION

It is an object of the present invention to obviate or mitigate at least one of the above-mentioned disadvantages of the prior art.

It is another object of the present invention to provide a novel process for producing a concentrated VRFB electrolyte composition.

Accordingly, in one of its aspects, the present invention provides a method for producing a concentrated VRFB electrolyte composition comprising the steps of:
(a) mixing a vanadium oxide, water and aqueous H₂SO₄ in sufficient quantities to produce a reaction mixture comprising a vanadium sulfate at a concentration at least 3.0 M and total sulfate concentration of at least 2 times the concentration of the vanadium sulfate;
(b) maintaining the reaction mixture at an initial temperature that substantially avoids precipition of reaction solids;
(c) allowing the reaction mixture to reach ambient temperature; and
(d) increasing the viscosity of the reaction mixture to produce the concentrated VRFB electrolyte composition.

In another of its aspects, the present invention provides a novel concentrated VRFB electrolyte composition.

A composition comprising vanadium sulfate at a concentration at least 3.0 M and a total sulfate concentration of at least 2 times the concentration of the vanadium sulfate, wherein the concentrated VRFB electrolyte composition is in the form a gel or a semi-solid and/or has a viscosity of at least 100 mPa.s at 20° C.

In yet another of its aspects, the present invention provides a concentrated VRFB electrolyte composition for use in a VRFB system, the composition comprising vanadium sulfate at a concentration at least 3.0 M and a total sulfate concentration of at least 2 times the concentration of the vanadium sulfate.

In yet another of its aspects, the present invention provides a novel method of producing VRFB electrolyte composition.

Thus, the present inventor has developed a novel method for producing a concentrated VRFB electrolyte composition. It is believed that this novel method obviates or mitigates one or more of the above-mentioned disadvantages and/or problems. Specifically, the present inventor has conceived of a method whereby the components conventionally used to produce a VRFB electrolyte composition are instead used in amounts and under conditions whereby a semi-solid (preferably gel-like) composition is produced—i.e., to produce a concentrated VRFB composition. This concentrated VRFB composition has a significantly lower water content than a conventional VRFB electrolyte composition that is ready for use. This feature of the concentrated VRFB electrolyte composition is believed to obviate or mitigate the problem of shipping costs and logistics discussed above with respect to transported ready to use VRFB electrolyte composition. In addition, this concentrated VRFB electrolyte composition is in the physical form of a semi-solid (preferably a gel)—e.g., in a preferred embodiment, this concentrated VRFB electrolyte composition is substantially non-pourable at ambient temperature (e.g., 20° C.-25° C.). This feature of the concentrated VRFB composition is believed to obviate or mitigate the problems of excessive weight and of sloshing/splashing discussed above with respect to transported ready to use VRFB electrolyte composition. In addition, this feature of the concentrated VRFB electrolyte composition is believed to obviate or mitigate the problem discussed above with respect to the capital expense and inconvenience associated with complex handling and metering of the components needed to produce the VRFB electrolye on-site at a VRFB facility using basic chemical ingredients.

In a highly preferred embodiment, the formation of the concentrated VRFB electrolyte composition is done in the present of a nucleation center (or site) and with mixing. The resulting concentrated VRFB composition is highly advantageous for the following reasons: (1) it can be formed relatively quickly; (2) it can lock all a relativley high amount of the free electrolytes and form a stable gel; and (3) it has relatively fast redissolution rate when water (preferably deinoized water) is added to form the VRFB electrolye on-site at the VRFB facility.

A parameter called densification level (DL) may be conventiently used to quantify the water removal level from the reaction mixture in Step (a) to the semi-solid concentrated VRFB (e.g., in gel form) electrolyte in Step (d):

$$DL = ( {Volume}_{removed water} / {Volume}_{total electrolyte} ) \times 100 \% .$$

In a preferred embodiment, the DL is at least 30%, more preferably from about 30% to about 70%, more preferably from about 40% to about 65%, more preferably from about 50% to about 65%, more preferably from about 50% to about 60%, preferably 50%.

### BRIEF DESCRIPTION OF THE DRAWINGS

Embodiments of the present invention will be described with reference to the accompanying drawings, wherein like reference numerals denote like parts, and in which:

FIG. 1 illustrates a schematic of the steps of a preferred embodiment of the present invention;

FIGS. 2 and 3 illustrate schematic details of a preferred osmotic module using in preferred embodiments of the present invention;

FIGS. 4-6 illustrate various results obtained in the Examples described below.

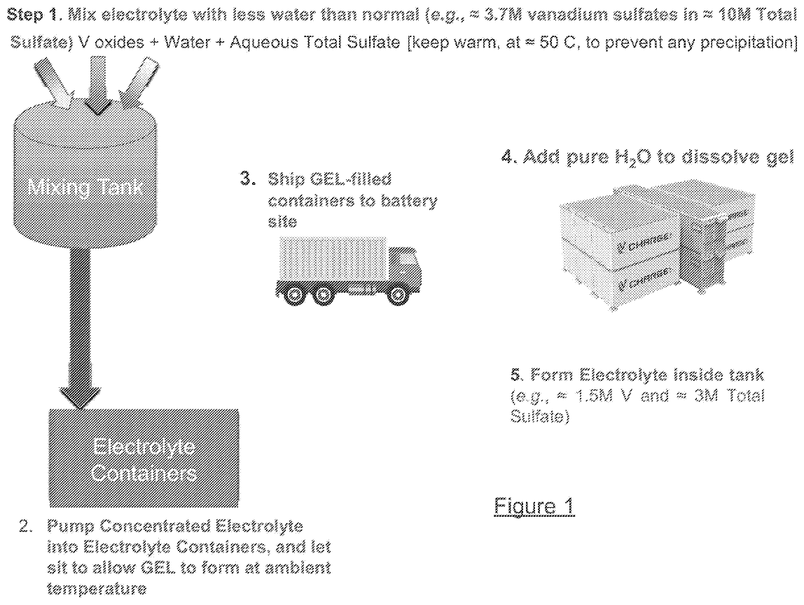

### DETAILED DESCRIPTION OF THE PREFERRED EMBODIMENTS

The present invention relates to a method for producing a concentrated VRFB electrolyte composition. The method comprises the following steps: (a) mixing a vanadium oxide, water and aqueous H₂SO₄ in sufficient quantities to produce a reaction mixture comprising a vanadium sulfate at a concentration at least 3.0 M and a total sulfate concentration of at least 2 times the concentration of the vanadium sulfate; (b) maintaining the reaction mixture at an initial temperature that substantially avoids precipition of reaction solids; (c) allowing the reaction mixture to reach ambient temperature; and (d) increasing the viscosity of the reaction mixture to produce the concentrated VRFB electrolyte composition. Preferred embodiments of this method may include any one or a combination of any two or more of any of the following features:
the vanadium oxide comprises V₂O₅;
the vanadium oxide comprises V₂O₃;
the vanadium oxide comprises a mixture of V₂O₅ and V₂O₃;
Step (a) comprises mixing a vanadium oxide, water and aqueous H₂SO₄ in sufficient quantities to produce a reaction mixture comprising a vanadium sulfate at a concentration in the range of from about 3.0 M to about 5.0 M and a total sulfate concentration of at least two times the concentration of the vanadium sulfate;
Step (a) comprises mixing a vanadium oxide, water and aqueous H₂SO₄ in sufficient quantities to produce a reaction mixture comprising a vanadium sulfate at a concentration in the range of from about 3.5 M to about 3.7 M and a total sulfate concentration of at least two times the concentration of the vanadium sulfate;
Step (a) comprises mixing a vanadium oxide, water and aqueous H₂SO₄ in sufficient quantities to produce a reaction mixture comprising a vanadium sulfate at a concentration of about 3.5 M and a total sulfate concentration of at least two times the concentration of the vanadium sulfate;
in Step (a), the concentration of total sulfate is from 2 to 4 times the concentration of the vanadium sulfate;
in Step (a), the concentration of total sulfate is from 2 to 3.5 times the concentration of the vanadium sulfate;
in Step (a), the concentration of total sulfate is from 2 to 3 times the concentration of the vanadium sulfate.
in Step (a), the concentration of total sulfate is from 2.5 to 3 times the concentration of the vanadium sulfate;
the initial temperature in Step (b) is at least about 50° C.;
the initial temperature in Step (b) is in the range of from about 60° C. to about 120° C.;
the initial temperature in Step (b) is in the range of from about 80° C. to about 120° C.;
the initial temperature in Step (b) is in the range of from about 100° C. to about 110° C.;
the initial temperature in Step (b) is about 105° C.;
the ambient temperature in Step (c) is in the range of from about 15° C. to about 40° C.;
the ambient temperature in Step (c) is in the range of from about 20° C. to about 30° C.;
the ambient temperature in Step (c) is in the range of from about 22° C. to about 28° C.;
the ambient temperature in Step (c) is in the range of from about 23° C. to about 25° C.;
prior to Step (c), the reaction mixture is dispensed into a storage container;
prior to Step (c), the reaction mixture is dispensed into a shipping container;
the concentrated VRFB electrolyte composition is in the form of a gel product;
prior to Step (c), the reaction mixture is subjected to a sub-process to produce a purified reaction mixture which is subjected to Step (d).
the purification sub-process comprises the following steps:
   (i) providing the reaction mixture from Step (b) which comprises a precipitation valence and contains at least one impurity that precipitates out of the reaction mixture when the valence of the reaction mixture is at or below the precipitation valence;
   (ii) reducing the reaction mixture to a valence below the precipitation valence so as to cause the at least one impurity to precipitate out of the reaction mixture as a precipitate; and
   (iii) mechanically separating the precipitate reaction mixture to produce the purified reaction mixture.
prior to Step (ii), the reaction mixture is subjected to a dilution step to produce a diluted reaction mixture;
the dilution step results in the diluted reaction mixture comprising vanadium sulfate at a concentration less than 3.0 M and a total sulfate concentration of at least 2 times the concentration of the vanadium sulfate;
the dilution step results in the diluted reaction mixture comprising vanadium sulfate at a concentration less than 3.0 M and a total sulfate concentration of at least 2 times the concentration of the vanadium sulfate;
the dilution step results in the diluted reaction mixture comprising vanadium sulfate at a concentration less than 2.8 M and a total sulfate concentration of at least 2 times the concentration of the vanadium sulfate;
the dilution step results in the diluted reaction mixture comprising vanadium sulfate at a concentration in the range of from about 1.2 M to about 2.5 M and a total sulfate concentration of at least 2 times the concentration of the vanadium sulfate;
the dilution step results in the diluted reaction mixture comprising vanadium sulfate at a concentration in the range of from about 1.2 M to about 2.0 M and a total sulfate concentration of at least 2 times the concentration of the vanadium sulfate;
the dilution step results in the diluted reaction mixture comprising vanadium sulfate at a concentration in the range of from about 1.4 M to about 1.8 M and a total sulfate concentration of at least 2 times the concentration of the vanadium sulfate;
the dilution step results in the diluted reaction mixture having a total sulfate concentration that is from 2 to 4 times the concentration of the vanadium sulfate;
the dilution step results in the diluted reaction mixture having a total sulfate concentration that is from 2 to 3.5 times the concentration of the vanadium sulfate;
the dilution step results in the diluted reaction mixture having a total sulfate concentration that is from 2 to 3 times the concentration of the vanadium sulfate;
the dilution step results in the diluted reaction mixture having a total sulfate concentration that is from 2.5 to 3 times the concentration of the vanadium sulfate;
the diluted reaction mixture is subjected to Steps (ii) and (iii) to produce a diluted, purified reaction mixture;
the diluted, purified reaction mixture is subjected to a concentration step to produce the purified reaction mixture;
the purified reaction mixture has a concentration of vanadium sulfate of at least 3.0 M and a total sulfate concentration of at least two times the concentration of the vanadium sulfate;
the purified reaction mixture bas a concentration of vanadium sulfate in the range of from about 3.0 M to about 5.0 M and a total sulfate concentration of at least two times the concentration of the vanadium sulfate;
the purified reaction mixture has a concentration of vanadium sulfate in the range of from about 3.0 M to about 4.0 M and a total sulfate concentration of at least two times the concentration of the vanadium sulfate;
the purified reaction mixture has a concentration of vanadium sulfate of about 3.3 M and a total sulfate concentration of at least two times the concentration of the vanadium sulfate;
the purified reaction mixture has a total sulfate concentration from 2 to 4 times the concentration of the vanadium sulfate;
the purified reaction mixture has a total sulfate concentration from 2 to 3.5 times the concentration of the vanadium sulfate;
the purified reaction mixture has a total sulfate concentration from 2 to 3 times the concentration of the vanadium sulfate;
the purified reaction mixture has a total sulfate concentration from 2.5 to 3 times the concentration of the vanadium sulfate;
the concentration step is conducted using reverse osmosis to produce extracted aqueous liquid from the diluted, purified reaction mixture;
the extracted aqueous liquid is used in the dilution step to produce the diluted, reaction mixture;
the extracted aqueous liquid is used as the only diluent in the dilution step to produce the diluted, reaction mixture;
in the extracted aqueous liquid is water;
the dilution step and the concentration step are conducted in an osmosis module;
an osmosis module is configured to pass aqueous liquid from the diluted, purified reaction mixture through a reverse osmosis membrane into the reaction mixture prior to Step (ii) to produce: (1) the diluted reaction mixture on the other side of the reverse osmosis membrane and (2) the purified reaction mixture on the opposite side of the reverse osmosis membrane;
the osmosis module is configured to use a pressure gradient to modulate the rate of transfer of aqueous liquid through the reverse osmosis membrane;
Step (d) comprises contacting the reaction mixture with a nucleation center;
the nucleation center comprises a mixture of liquid and solid;
the nucleation center comprises a solid;
the nucleation center comprises a woven or non-woven carbon-based cloth, paper or scrim material;
the nucleation center comprises a particulate material;
the nucleation center comprises a porous particulate material;
the nucleation center comprises a microporous particulate material;
the nucleation center comprises a carbon felt;
the nucleation center comprises a carbon powder;
the nucleation center comprises a zeolite;
the nucleation center comprises a vanadium salt such as a low-crystallinity vanadium salt (e.g., VOSO₄ salt);
the nucleation center comprises a VOSO₄ salt;
the nucleation center comprises a low crystallinity VOSO₄ salt;
the nucleation center (or site) is added to the reaction mixture in Step (d) in an amount of at least about 0.1 mg/mL, more preferably in an amount in the range of from about 0.1 mg/mL to about 20 mg/mL, more preferably in an amount in the range of from about 0.5 mg/mL to about 20 mg/mL, more preferably in an amount in the range of from about 1 mg/mL to about 20 mg/mL, more preferably in an amount in the range of from about 0.1 mg/mL to about 15 mg/mL, more preferably in an amount in the range of from about 1 mg/mL to about 10 mg/mL;
Step (d) is conducted with mixing of the reaction mixture;
mixing during Step (d) is done for a period of at least about 15 minutes, more preferably in the range of from about 15 minutes to about 180 minutes, more preferably in the range of from about 15 minutes to about 150 minutes, more preferably in the range of from about 30 minutes to about 120 minutes, more preferably in the range of from about 30 minutes to about 90 minutes, more preferably in the range of from about 30 minutes to about 60 minutes, more preferably 60 minutes;
the concentrated VRFB electrolyte composition produced in Step (d) has a DL which is at least 30%, more preferably from about 30% to about 70%, more preferably from about 40% to about 65%, more preferably from about 50% to about 65%, more preferably from about 50% to about 60%, preferably 50%.

The present invention also relates to a composition comprising vanadium sulfate at a concentration at least 3.0 M and a total sulfate concentration of at least 2 times the concentration of the vanadium sulfate. Preferred embodiments of this composition may include any one or a combination of any two or more of any of the following features:
the composition is in the form of a gel;
the composition is in the form of a semi-solid;
the composition has a viscosity of at least 100 mPa.s at 20° C.;
the composition comprises a concentration of vanadium sulfate as set out in Paragraph for the purified reaction mixture; and/or
the composition comprises a total sulfate concentration as set out in Paragraph [0022] for the purified reaction mixture.

The present invention also relates to a concentrated VRFB electrolyte composition for use in a VRFB system, the composition comprising vanadium sulfate at a concentration at least 3.0 M and a total sulfate concentration of at least 2 times the concentration of the vanadium sulfate (including when made by the above described method). Preferred embodiments of this composition may include any one or a combination of any two or more of any of the following features:
the concentrated VRFB electrolyte composition is in the form of a gel;
the concentrated VRFB electrolyte composition is in the form of a semi-solid;
the concentrated VRFB electrolyte composition has a viscosity of at least 100 mPa.s at 20° C.;
the concentrated VRFB electrolyte composition comprises a concentration of vanadium sulfate as set out in Paragraph [0022] for the purified reaction mixture; and/or
the concentrated VRFB electrolyte composition comprises a total sulfate concentration as set out in Paragraph [0022] for the purified reaction mixture.

The present invention also relates to a method for producing a VRFB electroyte composition comprising the step of contacting the concentrated VRFB electrolyte composition described above with an aqueous liquid. Preferred embodiments of this method may include any one or a combination of any two or more of any of the following features:
the aqueous liquid is water;
the aqueous liquid is added in an amount to produce the VRFB electrolyte composition comprising vanadium sulfate at a concentration less than 3.0 M and a total sulfate concentration of at least 2 times the concentration of the vanadium sulfate;
the aqueous liquid is added in an amount to produce the VRFB electrolyte composition comprising vanadium sulfate at a concentration less than 3.0 M and a total sulfate concentration of at least 2 times the concentration of the vanadium sulfate;
the aqueous liquid is added in an amount to produce the VRFB electrolyte composition comprising vanadium sulfate at a concentration less than 2.8 M and a total sulfate concentration of at least 2 times the concentration of the vanadium sulfate;
the aqueous liquid is added in an amount to produce the VRFB electrolyte composition comprising vanadium sulfate at a concentration in the range of from about 1.2 M to about 2.5 M and a total sulfate concentration of at least 2 times the concentration of the vanadium sulfate;
the aqueous liquid is added in an amount to produce the VRFB electrolyte composition comprising vanadium sulfate at a concentration in the range of from about 1.2 M to about 2.0 M and a total sulfate concentration of at least 2 times the concentration of the vanadium sulfate;
the aqueous liquid is added in an amount to produce the VRFB electrolyte composition comprising vanadium sulfate at a concentration in the range of from about 1.4 M to about 1.8 M and a total sulfate concentration of at least 2 times the concentration of the vanadium sulfate;
the aqueous liquid is added in an amount to produce the VRFB electrolyte composition comprising a total sulfate concentrationthat is from 2 to 4 times the concentration of the vanadium sulfate;
the aqueous liquid is added in an amount to produce the VRFB electrolyte composition comprising a total sulfate concentration that is from 2 to 3.5 times the concentration of the vanadium sulfate;
the aqueous liquid is added in an amount to produce the VRFB electrolyte composition comprising a total sulfate concentration that is from 2 to 3 times the concentration of the vanadium sulfate; and/or the aqueous liquid is added in an amount to produce the VRFB electrolyte composition comprising a total sulfate concentration that is from 2.5 to 3 times the concentration of the vanadium sulfate.

In Step (a) of the present process, it is preferred to use vanadium oxide in the form of V(III) and V(IV) only. During Step (a), in a preferred embodiment, it is preferred to keep the reaction mixture at a temperature of about 50° C. These preferred embodiments serve to reduce or eliminate the risk of precipitation of V₂O₅ during the process. Precipitation kinetics are believed to be very slow in the preferred embodiments.

In a preferred embodiment, in Step (a), the ingredients are used in amounts resulting in concentrations of vanadium sulfate and sulfuric acid that are at least 2 times the concentrations of those chemicals in ready to use VERB electrolytes. It is believed that such conditions for Step (a) facilitate osmosis driven dilution/concentration steps in a highly preferred embodiment of the present method.

In a preferred embodiment, the reaction mixture produced in Step (a) is subjected to a sub-process to produce a purified reaction mixture before it is subjected to Step (c). Purification of flow battery electrolytes can be performed using a variety of processes.

In a preferred embodiment, the purification process can be conducted at an elevated temperature or at ambient temperature (i.e., before or after Step (b)).

In a highly preferred embodiment, this sub-process comprises the following steps:
(i) providing the reaction mixture from Step (b) which comprises a precipitation valence and contains at least one impurity that precipitates out of the reaction mixture when the valence of the reaction mixture is at or below the precipitation valence;
(ii) reducing the reaction mixture to a valence below the precipitation valence so as to cause the at least one impurity to precipitate out of the reaction mixture as a precipitate; and
(iii) mechanically separating the precipitate reaction mixture to produce the purified reaction mixture

Additional details on and preferred embodiments of carrying out this sub-process may be found in U.S. Pat. No. 10,333,164 [Sullivan]. The entire content of Sullivan is incorporated herein (e.g., to allow some or all of the content of Sullivan to be included in the present specification for disclosure and claim support purposes).

Examples of other preferred embodiments of the purification sub-process may be found in U.S. Pat. No. 8,394,529 [Keshavarz et. al. (Keshavarz)] and also various of the documents cited on the cover page of Sullivan.

Since this sub-process may result in generation of hydrogen gas during the reduction step (i.e., Step (ii) above), it is preferred to subject the reaction mixture to a dilution step prior to the reduction step (i.e., Step (ii) above). Such a dilution step is also believed to reduce the viscosity of the reaction mixture to facilitate downstream processing.

In a preferred embodiment, the dilution step is carried out using an osmotic membrane. Preferably, in one embodiment, water is caused to spontaneously pass through a selective Reverse-Osmosis (RO) membrane from low-concentration solution to high-concentration solution. In a preferred embodiment, the concentrated solution may be aqueous sulfuric acid (H₂SO₄) with high concentration, preferably >10 M H₂SO₄, which may used as a draw solution to cause water to pass through the selective RO membrane from low-concentration solution to high-concentration solution. It is preferred to equalize the concentrations (e.g., same Osmotic pressure) across the RO membrane. Preferably, a pressure gradient may be applied to increase water-transfer rate. This is believed to enable the use of a smaller RO module. The RO process can be conducted at an elevated temperature or at ambient temperature. Although the highly concentrated electrolyte may not be stable over extended periods at ambient temperature, the precipitation kinetics are believed to be sufficiently slow to enable some processing at these lower temperatures.

The diluted reaction mixture is then subjected to the reduction step (i.e., Step (ii) above). Once the reaction mixture has been diluted, it may be subjected to the reduction step (i.e., Step (ii) above) which results in precipitation of any impurities in the reaction mixture. These impurities may then be mechanically removed (i.e, Step (iii)) resulting in production of a diluted, purified reaction mixture.

In a preferred embodiment, the diluted, purified reaction mixture is then subjected to a concentration step to produce a purified reaction mixture having a concentration of vanadium sulfate and sulfuric acid within the bounds set out for Step (a) above.

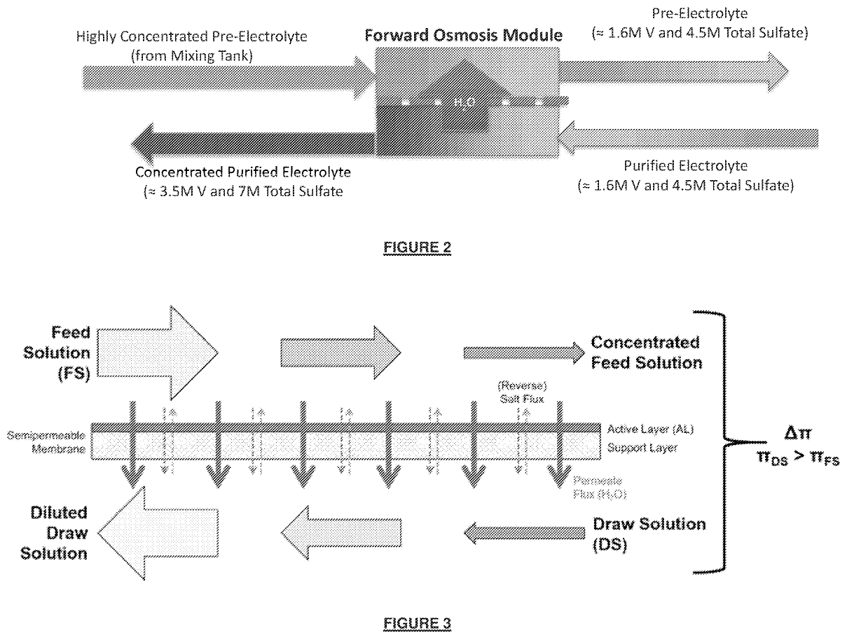

In a preferred embodiment the dilution and concentration steps are carried out in an osmosis module. In a highly preferred embodiment, the osmosis module is configured to pass aqueous liquid from the diluted, purified reaction mixture through a reverse osmosis membrane into the reaction mixture prior to Step (ii) to produce: (1) the diluted reaction mixture on the other side of the reverse osmosis membrane and (2) the purified reaction mixture on the opposite side of the reverse osmosis membrane. Additional details of the fluid flow patterns of the osmosis module may be found in FIGS. 2 and 3.

The module shown in FIGS. 2 and 3 may be regarded as Forward Osmosis (FO) module which may be used to separate water from dissolved solutes (it operates in a similar manner as a Reverse Osmosis (RO) membrane). The driving force is believed to be the difference in concentration (osmotic P gradient) with no applied hydraulic P required. In a preferred embodiment, concentrated aqueous sulfuric acid (H₂SO₄) is contacted with a semi-permeable membrane to cause water to migrate from a lower concentration solution (“Feed”) to a highly concentrated solution (“Draw”)—see FIG. 2.

In a preferred embodiment, Step (d) of the present method comprises contacting the reaction mixture (regardless of whether it has been purified pursuant to the preferred embodiments referred to above) with a nucleation center. It is believed that such contact reduces the time required to complete Step (d) to produce the concentrated VRFB eletrolyte—from hours (or even days) to minutes.

The following results are from a modelling study using a nucleation center for a different purpose:

Precipitation rate of VOSO [symbol] with and
without nucleation centers in unstirred solution

| | Test | | | | |
|---|---|---|---|---|---|
| Solution | Temp | | | Precipitation | |
| [symbol] | (° C.) | [symbol] | Nucleation Centers | Time | |
| 2. [symbol] | 20 | 1.0 | No addition of nucleation materials | 4 | day |
| 2. [symbol] | 20 | 0.6 | No addition of nucleation materials | 10 | day |
| 3.2 | 20 | 1.4 | Activated carbon [symbol] elt | [symbol] 0 | min |
| 3.2 | 20 | 1.4 | HNO [symbol] -treated XC72R (carbon | 45 | min |
| | | | powder) | | |
| 2. [symbol] | 20 | 1.0 | 10 wt [symbol] Zeolite Y [symbol] to VO [symbol] O [symbol] | 75 | min |
| [symbol] | 20 | 1.4 | [symbol] | [symbol] | min |

[symbol]

Low-crystallinity VO [symbol] O [symbol] is solid [symbol] from over [symbol] solution triggered by activated carbon [symbol] [symbol]
indicates data missing or illegible when filed

More details are available from T. Van Nguyen and Y. Li, Electrochem. Soc. (ECS) Presentations, A03-0204 and A03-0205 (2021). 239^{th} ECS Meeting with the 18^{th} International Meeting on Chemical Sensors (IMCS) (May 30-Jun. 3, 2021) (confex.com). See also “A Solid/Liquid High-Energy-Density Storage Concept for Redox Flow Batteries and Its Demonstration in an H₂-V System”, T. Van Nguyen and Y. Li, Paper ID APEN-MIT-2021_023, Applied Energy Symposium: MIT A+B Aug. 11-13, 2021. Cambridge, USA. See also Yuanchao Li and Trung Van Nguyen 2022 J. Electrochem. Soc. 169 110509. See also International Publication Number WO 2021/108244A1 [Nguyen et al.].

In a preferred embodiment, the nucleation center (or site) is disposed in an electrolyte container. This is believed to be advantageous when the nucleation center (or site) comprises a carbon based material such as carbon felt.

In a preferred embodiment, the nucleation center (or site) is introduced from a small reservoir located upstream of the electrolyte container. This is believed to be advantageous when the nucleation center (or site) comprises a zeolite and/or a vanadium salt such as a high crystallinity vanadium salt or a low-crystallinity vanadium salt (e.g., VOSO₄ salt).

In a preferred embodiment the nucleation center (or site) is vanadium salt such as a low-crystallinity vanadium salt (e.g., VOSO₄ salt). This embodiment is believed to be be particularly advantageous since the nucleation center can be produced in situ and does not required addition of a foreign material during Step (d). Also, the use of a low-crystallinity vanadium salt (e.g., VOSO₄ salt) as the nucleation center (or site) is believed to promote gel formation and improve redissolution times.

In a preferred embodiment the nucleation center (or site) is added to the reaction mixture in Step (d) in an amount of at least about 0.1 mg/mL, more preferably in an amount in the range of from about 0.1 mg/mL to about 20 mg/mL, more preferably in an amount in the range of from about 0.5 mg/mL to about 20 mg/mL, more preferably in an amount in the range of from about 1 mg/mL to about 20 mg/mL, more preferably in an amount in the range of from about 0.1 mg/mL to about 15 mg/mL, more preferably in an amount in the range of from about 1 mg/mL to about 10 mg/mL.

In a preferred embodiment, Step (d) of the present method comprises contacting the reaction mixture (regardless of whether it has been purified pursuant to the preferred embodiments referred to above) with a nucleation center and with mixing. The term “mixing”, as used in this context, is intended to have a broad meaning and includes subjecting the reaction mixture to mechanical energy. The source of mechanical energy is not particularly restricted and includes devices that add kinetic energy to the reaction mixture.

In a preferred embodument, the device that adds kinetic energy to the reaction mixture may be a solid-solid mixer or a solid-liquid mixer. Non-limiting examples of such a device include a kneader, an extruder, a tumbler, a ribbon mixer, a muller and the like.

In a preferred embodument, the device that adds kinetic energy to the reaction mixture may be liquid-liquid mixer or a liquid-gas mixer. Non-limiting examples of such a device include a static mixer, mechanically mixed tanks, a jet mixer and the like.

In a preferred embodiment, the device that adds kinetic energy to the reaction mixture may be magnetic-based. A non-limiting example of such a device is a vessel configured to create a rotating magnetic field in the reaction mixture to cause a magnetic element (e.g., a bar, a plate, etc.) immersed in the reaction mixture to cause agitation thereof.

In another preferred embodiment, the device that adds kinetic energy to the reaction mixture is a stirred reactor such as a continuous stirred-tank reactor (CSTR), also known as vat-or backmix reactor, mixed flow reactor (MFR), or a continuous-flow stirred-tank reactor (CFSTR).

In a preferred embodiment, mixing discussed above during Step (d) is done for a period of at least about 15 minutes, more preferably in the range of from about 15 minutes to about 180 minutes, more preferably in the range of from about 15 minutes to about 150 minutes, more preferably in the range of from about 30 minutes to about 120 minutes, more preferably in the range of from about 30 minutes to about 90 minutes, more preferably in the range of from about 30 minutes to about 60 minutes, more preferably 60 minutes.

A semi-solid concentrated VRFB (e.g., in gel form) electrolyte is formed in the electrolyte container or even upstream thereof in Step (d). This is the result of denisfying the reaction mixture in Step (a) by removing water to produce the semi-solid concentrated VRFB (e.g., in gel form) electrolyte in Step (d).

After the semi-solid concentrated VRFB (e.g., in gel form) is formed in the electrolyte container, the latter may be loaded onto a transportion vehicle (e.g., truck, rail cars, etc.) and transported to the VRFB site. The semi-solid concentrated VRFB (e.g., in gel form) has reduced weight compared to ready to use VRFB electrolyte allowing for transport of large amounts of equivalent electrolyte possible with fewer shipments.

At the VRFB site, the semi-solid concentrated VRFB electrolyte (e.g., in gel form) may be contacted with an aqueous liquid (e.g., water) to produce ready to use VRFB electrolyte. The time required for dissolution may be reduced by the use of low-crystallinity salts as a nucleation center (or site) as described above. Notwithstanding this, it is believed that dissolution is typically faster than precipitation.

The time required may also optionally be decreased by heating the concentrated VRFB electrolyte and aqueous liquid mixture. This heating may be accomplished by starting the “formation charge” prior to dissolution of all of the salts.

### EXAMPLES

Embodiments of the invention will be illustrated with references to the following Examples which should not be used to limit or construe the scope of the invention.

### Densification Process

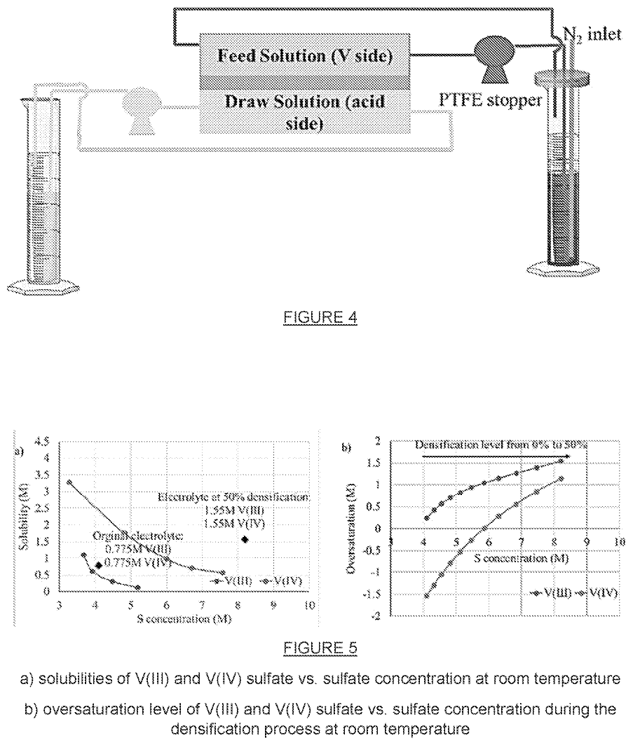

A forward osmosis (FO) apparatus have the schematics shown in FIG. 4 was used to densify the electrolyte.

The FO apparatus used an osmotic process that separates water from dissolved solutes using a semi-permeable membrane, with the driving force being the osmotic pressure gradient between the draw solution side (high-concentration) and the feed solution side (low-concentration). The higher osmotic pressure of the draw solution induces a net water flux across the membrane from the lower osmotic pressure feed solution.

In this case, the feed solution was a vanadium electrolyte composition comprising approximately 1.55 M V^{3.5+} (V(III) to V(IV) molar ratio of 1:1) and 2 M H₂SO₄. The water content was calculated to be about 51 M or 66 mass %, with the density of the vanadium electrolyte composition being 1.4 g/cm³. The draw solution was 15 M-17 M concentrated sulfuric acid.

Since both sides contained strong acids, a Nafion® membrane was used instead of the less stable commercial FO membranes, such as the cellulose triacetate (CTA) membrane. The device was adapted from a standard flow battery with interdigitated flow fields and a Nafion® membrane sandwiched between two porous carbon felts, which served as porous supportingsubstrates for the membrane. This configuration is similar to the membrane electrode assembly (MEA) of a flow battery. Both the draw and feed solutions were recirculated through the FO cell until the feed solution reached the desired densification level.

The graduating cylinders in FIG. 4 were utilized to record and measure the withdrawn water volume.

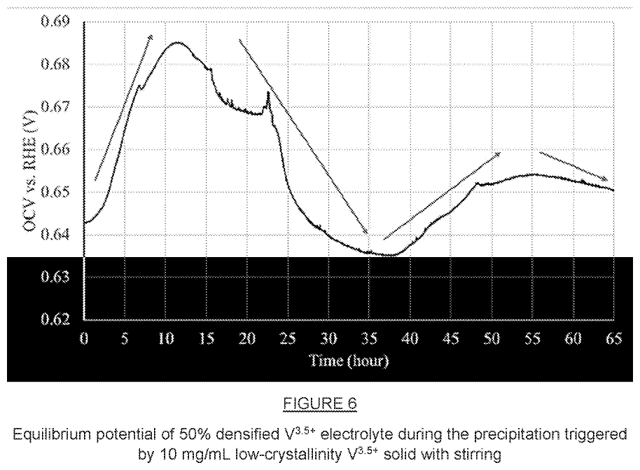

After the osmosis process removes the water, the electrolyte concentrations of V(III) and V(IV) increase. When the concentration exceeds the solubility, the oversaturated solution can be precipitated out as a solid. The as-received LCE's electrolyte is stable at RT because, based on the literature data in FIG. 5, V(IV) in the electrolyte is undersaturated and V(III) is only slightly oversaturated. When the electrolyte was densified from 0 to 50% by removing water, both V(IV) and V(III) became oversaturated, allowing them to be precipitated.

### Co-Precipitation of V(III) and V(IV)

The results illustrated in FIG. 5 implies that both V(III) and V(IV) are oversaturated at 50% DL. An electrochemical method was used to identify which species would be the first to precipitate. The vanadium electrolyte was densified in the FO-cell in FIGS. 4 to 50% and then mixed with 10 mg/mL low-crystallinity V3.5+ nucleation material (produced with 50% densified electrolyte and precipitated by activated carbon felt as a nucleation center). The open-circuit voltage (OCV) change during the precipitation process was monitored by a two-electrode system consisting of a graphite rod as the working electrode and a mercury sulfate reference electrode (MSE) as the reference electrode.

The Nernst equation for the V(IV)/V(III) redox couple can be represented as follows:

$$E = {E}^{⊖} + RT / F * ln ( [ V ( IV ) ] / [ V ( III ) ] )$$

This relationship shows that increasing OCV can only come from decreasing [V(III)] (if V(III) precipitates out of the solution) and decreasing OCV is due to decreasing [V(IV)] (if V(IV) precipitates).

The OCV response shown in FIG. 6 fluctuates by increasing first and then decreasing. From the Nernst equation and the fact that V(III) was much more oversaturated, it can be inferred that V(III) is the first species to precipitate followed by V(IV).

After the first round of precipitation of V(III) and V(IV), some of the free water molecules are locked within the precipitates, resulting in the oversaturation of both species. This process is repeated as shown by the oscillating pattern in FIG. 6. The precipitation process can continue to occur within the liquid part of the gel network until the system reaches some equilibrium level.

### Precipitation and Dissolution Process of V^{3.5+} Electrolyte Composition

As discussed, the low-crystallinity gel is advantageous since it can be redissolved quickly.

Three cases were carried out. In all three instances, the densified electrolyte was the 60% densified V^{3.5+} electrolyte.

In Case A, 10 mg/mL of low crystallinity V^{3.5+} solid was added to the densified solution as the nucleation material and in stirring was applied. Case B had the same nucleation material density but with stirring. Case C had no nucleation material and no stirring.

Once mixed and allowed to sit, the slurry in case B eventually formed a gel with very low flowability. Cases A and C eventually also formed precipitates. In contrast to Case B, the precipitates in Cases A and C were highly crystalline solids. While Cases A and C each represent an andvance in the art, they have a slower dissolution rate and the crystalline solids lock a less amount of the free water inside the precipitate.

The redissolution performance of the two types of precipitates was investigated. Deionized (DI) water was added to the precipitates in each of Case A, Case B and Case C to return the total vanadium concentration to 110% of its original level (i.e., 10% more concentrated than the original concentration). The redissolution rate of Case B (the low-crystallinity gel) was much faster than that Case A and Case C (each the high-crystallinity solid) i.e., 40 seconds vs. 1.5 hr. The shorter dissolution rate of Case B (the low-crystallinity gel) can significantly simplify the electrolyte recovery process at the installation site.

Accordingly, for the cases exemplied, Case B is believed to be the most preferred embodiment for commercial purposes.

### Potential Gel Formation Mechanism

The following is provided has a potential gel formation mechanism and the explanation is believed to explain the observations made. However, it should be understood that the present invention should not be defined or restricted to any particular theory or mode of operation.

Case B above is believed to be the most preferred embodiment for commercial purposes because: (1) it can precipitate out relatively quickly; (2) it can lock all a relatively high amount of the free electrolytes and form a stable gel; and (3) it has relatively fast redissolution rate when DI water is added to dissolve it back to the original concentration level (the VRFB electrolyte).

After the nucleation material is added to the oversaturated electrolyte and the mixture is stirred for a period of time and allowed to sit, large and visible particles settle to the bottom of the container while sub-nanoparticles (sub-NPs) are suspended in the solution because of their small sizes. These suspended sub-NPs continue to grow, and if there is a sufficient amount of them to form an interconnected network that can immobilize most of the free water molecules, a gel is formed.

Due to the difference in density, as the sub-NPs grow in size and become denser, they flow to the bottom while the lighter water molecules flow to the top. This can create phase separation and cause the solution to become a slurry (mixture of solid and liquid). Therefore, the full gel formation requires a sufficient number of suspended sub-NPs to grow and form a network before the phase separation occurs.

This potential mechanism assumes that it is the sub-NPs suspending in the solution instead of the large nucleation material sitting in the bottom of the solution that triggers the slurry precipitation and forms the gel network. If this is correct, the mixing operation can end once sufficient sub-NPs are generated, therefore considerably shortening the stirring phase. Two solutions with the same densification level and nucleation material density but different volumes are applied to the same vial size to test this concept.

Once stirred and allowed to sit, the large nucleation particles settle to the bottom, resulting in different diffusion lengths between the ions in the solution and the particles sitting on the bottom of the vials for the two cases with different solution volumes. If the suspended sub-NPs determine the final gel formation, the two cases should show similar slurry/gel generation rates regardless of the diffusion length; alternatively, if the slurry/gel formation starts from the large nucleation materials sitting on the bottom of the vials, the case with the shorter diffusion length (i.e., lower volume) should show a faster slurry/gel formation rate because the vanadium ions can more quickly reach the surface of the nucleation materials.

It was found that both cases had the same slurry and gel formation rates, thus proving the concept. Since the mechanism depends only on the density of the sub-NPs in the solution and not the total volume of the electrolyte, it is believed to allow for the use of smaller electrolyte volumes in high-throughput applications.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A method for producing a concentrated VRFB electrolyte composition comprising the steps of:
(a) mixing a vanadium oxide, water and aqueous H₂SO₄ in sufficient quantities to produce a reaction mixture comprising a vanadium sulfate at a concentration at least 3.0 M and a total sulfate concentration of at least 2 times the concentration of the vanadium sulfate;
(b) maintaining the reaction mixture at an initial temperature that substantially avoids precipitation of reaction solids;
(c) allowing the reaction mixture to reach ambient temperature; and
(d) increasing the viscosity of the reaction mixture to produce the concentrated VRFB electrolyte composition.

2. The method defined in claim 1, wherein the vanadium oxide comprises one or both of V₂O₅ and V₂O₃.

3. The method defined in claim 1, wherein Step (a) comprises mixing a vanadium oxide, water and aqueous H₂SO₄ in sufficient quantities to produce a reaction mixture comprising a vanadium sulfate at a concentration in the range of from about 3.0 M to about 5.0 M and a total sulfate concentration of at least two times the concentration of the vanadium sulfate.

4. The method defined in claim 1, wherein, in Step (a), the concentration of total sulfate is from 2 to 4 times the concentration of the vanadium sulfate.

5. The method defined in claim 1, wherein the initial temperature in Step (b) is at least about 50° C.

6. The method defined in claim 1, wherein the ambient temperature in Step (c) is in the range of from about 15° C. to about 40° C.

7. The method defined in claim 1, wherein, prior to Step (c), the reaction mixture is dispensed into a storage container, and the reaction mixture is dispensed into a shipping container.

8. The method defined in claim 1, wherein the concentrated VRFB electrolyte composition is in the form of a gel product.

9. The method defined in claim 1, wherein prior to Step (c), the reaction mixture is subjected to a sub-process to produce a purified reaction mixture which is subjected to Step (d), wherein the purification sub-process comprises the following steps:
(i) providing the reaction mixture from Step (b) which comprises a precipitation valence and contains at least one impurity that precipitates out of the reaction mixture when the valence of the reaction mixture is at or below the precipitation valence;
(ii) reducing the reaction mixture to a valence below the precipitation valence so as to cause the at least one impurity to precipitate out of the reaction mixture as a precipitate; and
(iii) mechanically separating the precipitate reaction mixture to produce the purified reaction mixture.

10. The method defined in claim 9, wherein, prior to Step (ii), the reaction mixture is subjected to a dilution step to produce a diluted reaction mixture, wherein the dilution step results in the diluted reaction mixture comprising vanadium sulfate at a concentration less than 3.0 M and a total sulfate concentration of at least 2 times the concentration of the vanadium sulfate.

11. The method defined in claim 10, wherein the dilution step results in the diluted reaction mixture having a total sulfate concentration that is from 2 to 4 times the concentration of the vanadium sulfate.

12. The method defined in claim 11, wherein the diluted reaction mixture is subjected to Steps (ii) and (iii) to produce a diluted, purified reaction mixture; the diluted, purified reaction mixture is subjected to a concentration step to produce the purified reaction mixture and the purified reaction mixture has a concentration of vanadium sulfate of at least 3.0 M and a total sulfate concentration of at least two times the concentration of the vanadium sulfate.

13. The method defined in claim 12, wherein the concentration step is conducted using reverse osmosis to produce an extracted aqueous liquid from the diluted, purified reaction mixture, wherein the extracted aqueous liquid is used in the dilution step to produce the diluted, reaction mixture, and wherein the extracted aqueous liquid is used as the only diluent in the dilution step to produce the diluted, reaction mixture.

14. The method defined in claim 12, wherein the dilution step and the concentration step are conducted in an osmosis module and wherein the osmosis module is configured to pass an aqueous liquid from the diluted, purified reaction mixture through a reverse osmosis membrane into the reaction mixture prior to Step (ii) to produce: (1) the diluted reaction mixture on the other side of the reverse osmosis membrane and (2) the purified reaction mixture on the opposite side of the reverse osmosis membrane, and wherein the osmosis module is configured to use a pressure gradient to modulate the rate of transfer of aqueous liquid through the reverse osmosis membrane.

15. The method defined in claim 1, wherein Step (d) comprises contacting the reaction mixture with a nucleation center, and wherein the nucleation center comprises a solid, a liquid or a mixture of liquid and a solid.

16. The method defined in claim 15, wherein the nucleation center is selected from the group consisting of a porous particulate material, a microporous particulate material, a carbon felt, a carbon powder, a zeolite, a VOSO₄ salt, vanadium salt, a high crystallinity vanadium salt or a low-crystallinity vanadium salt and any mixture of two or more of these.

17. The method defined in claim 15, wherein the nucleation center is used in an amount of at least about 0.1 mg/mL.

18. The method defined in claim 1, wherein Step (d) is conducted with mixing of the reaction mixture and wherein mixing during Step (d) is done for a period of at least about 15 minutes.

19. The method defined in claim 1, wherein: (i) the concentrated VRFB electrolyte composition produced in Step (d) has a densification level (DL) which is at least 30% and (ii) the densification level is calculated as follows: DL=(Volume_{removed water}/Volume_{total electrolyte})×100%.

20. The concentrated VRFB electrolyte composition produced according to the method defined in claim 1.

21. A method for producing a VRFB electrolyte composition comprising the step of contacting the concentrated VRFB electrolyte composition defined in claim 20 with an aqueous liquid.

22. The method defined in claim 21, wherein the aqueous liquid is added in an amount to produce the VRFB electrolyte composition comprising vanadium sulfate at a concentration less than 3.0 M and a total sulfate concentration of at least 2 times the concentration of the vanadium sulfate.

23. A composition, the composition comprising vanadium sulfate at a concentration at least 3.0 M and a total sulfate concentration of at least 2 times the concentration of the vanadium sulfate, wherein the composition is in the form a gel or a semi-solid and/or has a viscosity of at least 100 mPa.s at 20° C.

24. The composition defined in claim 23, wherein the purified reaction mixture has a concentration of vanadium sulfate of at least 3.0 M and a total sulfate concentration of at least two times the concentration of the vanadium sulfate.

25. (canceled)

26. (canceled)
